(19) United States
(12) Patent Application Publication
(10) Pub. No.: US 2019/0283375 A1
(43) Pub. Date: Sep. 19, 2019

(54) POLYMER BLENDS FOR USE IN MULTILAYERED TUBING FOR FUEL TRANSFER APPLICATIONS

(71) Applicant: Saint-Gobain Performance Plastics Corporation, Solon, OH (US)

(72) Inventor: James Ludlow, Medina, OH (US)

(21) Appl. No.: 16/358,571

(22) Filed: Mar. 19, 2019

Related U.S. Application Data
(60) Provisional application No. 62/645,048, filed on Mar. 19, 2018.

(51) Int. Cl. B32B 27/08; B32B 27/30; B32B 27/32; C08L 23/08; C08L 27/16; C08L 33/10; B32B 1/08

(52) U.S. Cl. CPC B32B 27/08; B32B 27/304; B32B 27/32; C08L 23/0846; C08L 2205/08; C08L 33/10; B32B 1/08; B32B 2597/00; C08L 2203/18; C08L 27/16

(57) ABSTRACT

The present disclosure relates generally to polymer-based tubing, suitable, for example, for conducting hydrocarbon fuels. The present disclosure relates more particularly to multi-layered tubings that are fuel resistant, flexible, and cost effective.

### CROSS-REFERENCE TO RELATED APPLICATIONS

This application claims the benefit of priority of U.S. Provisional Patent Application No. 62/645048, filed Mar. 19, 2018, which is hereby incorporated by reference herein in its entirety.

### BACKGROUND OF THE DISCLOSURE

### 1. Field of the Disclosure

The present disclosure relates generally to polymer-based tubing, suitable, for example, for conducting hydrocarbon fuels. The present disclosure relates more particularly to multi-layered tubings that are fuel resistant, flexible, and cost effective.

### 2. Technical Background

Multilayered or laminated rubber tubings are known to be useful to serve as a fuel transporting hose for a hydrocarbon fuel feed line into a vehicle or device reservoir. Such tubings are generally required to have a low permeability to fuel vapor, so as to reduce the amount of hydrocarbon vapor released to the environment. The United States Environmental Protection Agency sets certain regulations that limit the release of hydrocarbons into the environment. The regulations for handheld devices and marine applications are more stringent, requiring a maximum permeation rate of less than 15 g/m²/day and less than 5 g/m²/day, respectively. The permeation measurements are performed on circulating fuel, measuring the capture of hydrocarbons permeating through the tube wall at a test temperature of 40° C.

It is highly desirable that fuel tubings meet the most rigorous requirements for permeability to fuel vapor. To meet these strict evaporative emission standards, barrier layers are often used in fuel tubing. Thermoplastic fluoropolymers are an especially attractive material for use as barrier layers. They have a unique combination of properties, such as high thermal stability, chemical inertness and non-stick release properties. But thermoplastic fluoropolymers are expensive in comparison to many other polymers, and often do not provide the necessary strength and flexibility to a tubing. Accordingly, tubings are often formed as multilayer structures, in which one or more additional polymer layers can contribute their own properties and advantages such as, for example, low density, elasticity, sealability, scratch resistance and the like. Co-extrusion is often used to form such multilayer tubings.

Chemically functionalized fluoropolymers are often used as a barrier layer. Such materials are relatively flexible, however, they are expensive and can require barrier layers of 0.010″ (˜0.254 mm) and thicker to meet evaporative emission standards. Ethylene vinyl alcohol (EVOH) copolymers also often used as barrier layers, while inexpensive, have high modulus and low flexibility.

Therefore, there remains a need for improved and flexible multilayer fuel tubing that are not only chemically resistant to hydrocarbon fuels and have very low permeability to hydrocarbon fuels, but also have lower costs.

### SUMMARY OF THE DISCLOSURE

In one aspect, the present disclosure provides a length of tubing having an annular cross-section, the annular cross-section having an inner surface and an outer surface, the annular cross-section including:
an annular barrier layer formed from a barrier mixture comprising ethylene vinyl alcohol copolymer and one or more fluoropolymers, wherein the combined content of ethylene vinyl alcohol copolymer and the one or more fluoropolymers in the barrier layer is in an amount of at least 75 wt %, and the barrier layer having an outer surface and an inner surface.

In another aspect, the disclosure provides methods for transporting a hydrocarbon fuel, the method including
providing a length of tubing having an annular cross-section, the annular cross-section having an inner surface and an outer surface, the annular cross-section including:
   an annular barrier layer formed from a barrier mixture comprising ethylene vinyl alcohol copolymer and one or more fluoropolymers, wherein the combined content of ethylene vinyl alcohol copolymer and the one or more fluoropolymers in the barrier layer is in an amount of at least 75 wt %, and the barrier layer having an outer surface and an inner surface; and
flowing the hydrocarbon fuel through the flexible tubing from a first end to a second end thereof.

In another aspect, the disclosure provides fuel-powered devices including:
a fuel tank,
a fuel-powered engine, and
a length of tubing fluidly connecting the fuel tank with the fuel-powered engine, and having an annular cross-section, the annular cross-section having an inner surface and an outer surface, the annular cross-section including:
   an annular barrier layer formed from a barrier mixture comprising ethylene vinyl alcohol copolymer and one or more fluoropolymers, wherein the combined content of ethylene vinyl alcohol copolymer and the one or more fluoropolymers in the barrier layer is in an amount of at least 75 wt %, and the barrier layer having an outer surface and an inner surface.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a side schematic view of a length of tubing according to one embodiment of the disclosure;

FIG. 2 is a cross-sectional schematic view of the length of tubing of FIG. 1;

FIG. 3 is a cross-sectional schematic view of a length of tubing according to another embodiment of the disclosure; and

FIG. 4 is a cross-sectional schematic view of a length of tubing according to another embodiment of the disclosure.

FIG. 5 is a set of graphs illustrating tensile properties data for the barrier layer films prepared from the polymers of Examples 1-10.

FIG. 6 is a set of graphs illustrating fuel permeation data for the barrier layer films prepared from the polymers of Examples 1-10.

### DETAILED DESCRIPTION

Before the disclosed processes and materials are described, it is to be understood that the aspects described herein are not limited to specific embodiments, apparati, or configurations, and as such can, of course, vary. It is also to be understood that the terminology used herein is for the purpose of describing particular aspects only and, unless specifically defined herein, is not intended to be limiting.

Throughout this specification, unless the context requires otherwise, the word “comprise” and “include” and variations (e.g., “comprises,” “comprising,” “includes,” “including”) will be understood to imply the inclusion of a stated component, feature, element, or step or group of components, features, elements or steps but not the exclusion of any other integer or step or group of integers or steps.

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

In view of the present disclosure, the methods and compositions described herein can be configured by the person of ordinary skill in the art to meet the desired need. In general, the disclosed materials, methods, and apparati provide improvements in multilayer fuel tubing. The inventors have unexpectedly determined that use of a blend of ethylene vinyl alcohol copolymer and one or more fluoropolymers in the barrier layer of the tubing can provide a flexible tubing that has a high resistance to hydrocarbon fuels and to permeance of fuel vapors, but also reduces overall costs for the tubing.

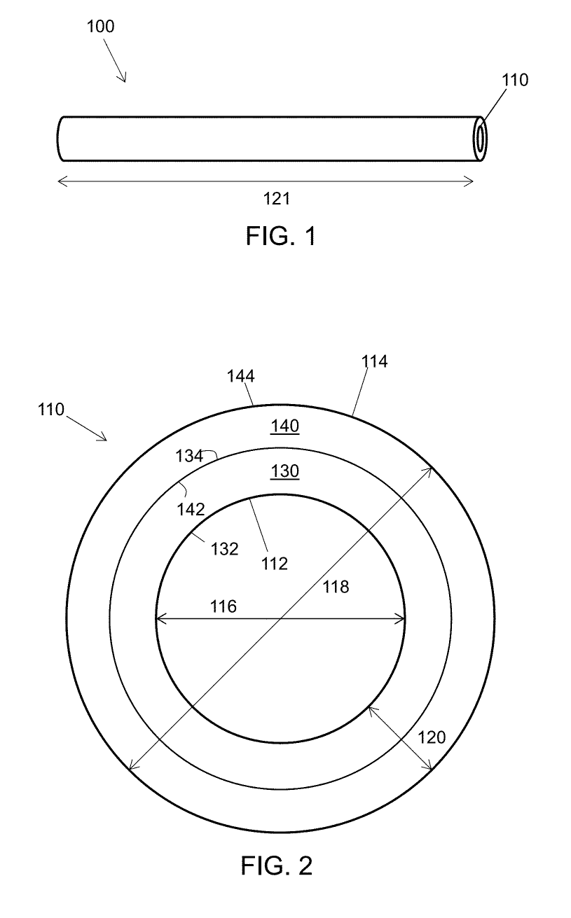

Accordingly, one aspect of the disclosure is a length of flexible tubing having an annular cross-section, the annular cross-section having an inner surface and an outer surface. Such a tubing is shown in schematic perspective view in FIG. 1, and in schematic cross-sectional view in FIG. 2. Flexible tubing 100 includes has an annular cross-section 110 (shown in detail in FIG. 2), which has an inner surface 112, an outer surface 114, an inner diameter 116 and an outer diameter 118. The inner diameter and the outer diameter define a wall thickness 120 of the tubing. Flexible tubing 100 also has a length 121.

Flexible tubing 100 is shown as being circular in overall shape. Of course, the person of ordinary skill in the art will appreciate that the tubing can be fabricated in other overall shapes, e.g., oval, elliptical, or polygonal. Similarly, while flexible tubing 100 is shown as having a radially constant wall thickness, the person of ordinary skill in the art will appreciate that in other embodiments, the thickness need not be constant. In such cases, the “thickness” is taken as the radially-averaged thickness. In certain desirable embodiments, the wall thickness at any one point along the circumference of the tubing is not less than 50%, or no less than 60%, or no less than 70% of the average thickness.

The annular cross-section of the tubing 100 comprises an annular barrier layer 130, which is formed from at least 75 wt % of ethylene vinyl alcohol copolymer and the one or more fluoropolymers, and has an inner surface 132 and an outer surface 134. In the embodiment of FIG. 1, disposed about the barrier layer is an annular support layer 140, and has an inner surface 142 that is in contact with the outer surface 134 of the barrier layer, and an outer surface 144.

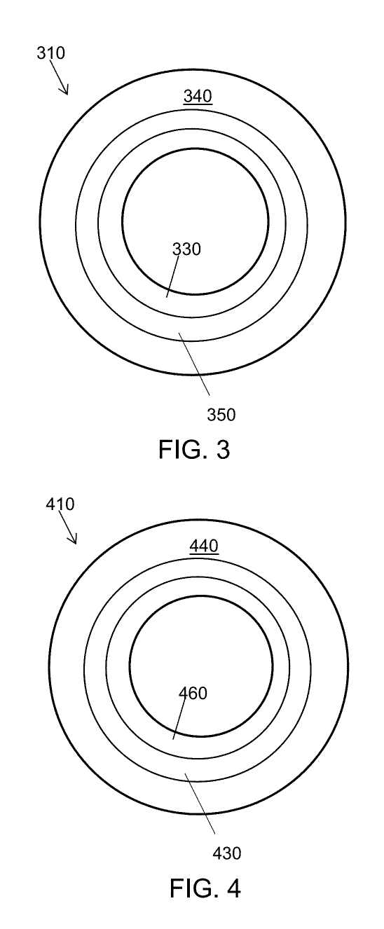

The person of ordinary skill in the art will appreciate that the tubings of the disclosure can be configured in many ways. For example, in certain embodiments as otherwise described embodiments, the annular cross-section further includes one or more inner annular polymer or tie layers disposed on the outside surface of the barrier layer. Such an embodiment is shown in the cross-sectional schematic view of FIG. 3. Here, annular cross-section 310 includes not only a barrier layer 330 and a support layer 340, but also one or more (here, one) inner annular polymer or tie layers 350 disposed on the outside surface of the barrier layer. Thus, in certain embodiments, the inner surface of the barrier layer forms the inner surface of the tubing. Of course, in other embodiments, the annular cross-section further includes one or more inner annular polymer or tie layers disposed on the inner surface of the barrier layer. Such an embodiment is shown in the cross-sectional schematic view of FIG. 4. Here, annular cross-section 410 includes not only a barrier layer 430 and a support layer 440, but also one or more (here, one) inner annular polymer layers 460 disposed on the inner surface of the barrier layer. Thus, in certain embodiments, the annular cross-section further comprises one or more inner annular polymer layers disposed on the inner surface of the barrier layer. In certain other embodiments, the annular cross-section further comprises one or more outer annular support layers disposed on the outer surface of the barrier layer. In such embodiments, the outer surface of the support layer forms the outer surface of the tubing.

As described above, the barrier layer is formed from a substantial amount of, i.e., at least 75 wt %, of ethylene vinyl alcohol copolymer and the one or more fluoropolymers combined, based on the total weight of the barrier mixture. The person of ordinary skill in the art will appreciate that a variety of additional materials can be used in the barrier layer, e.g., to aid in processing or to provide a desired appearance of the barrier layer. The person of ordinary skill in the art will appreciate that a variety of commercial EVOH and fluoropolymer grades can be suitable for use in the tubings described herein. In certain embodiments of the tubings as otherwise described herein, the barrier layer is formed from at least 80 wt % of ethylene vinyl alcohol copolymer and the one or more fluoropolymers combined, based on the total weight of the barrier mixture, for example, at least 85 wt %, at least 90 wt %, at least 95 wt %, or even at least 98 wt %. In other embodiments as otherwise described herein, the barrier mixture consists essentially of ethylene vinyl alcohol copolymer and the one or more fluoropolymers.

Ethylene vinyl alcohol copolymer, as used herein, is a polymer having at least 40 mol % (e.g., at least 50 mol %) vinyl alcohol residues, and the remainder being ethylene residue. Desirable EVOH copolymers include, for example, the copolymers of vinyl alcohol and ethylene, usually in ratios of about 58:32 mol % to about 52:48 mol %, about 57:33 mol % to about 55:45 mol %, or about 56:44 mol %. Commercially available EVOH materials include, for example, those having the trade designations “EVAL” as marketed by Kuraray.

Ethylene vinyl alcohol copolymer can be present in the barrier mixture in an amount in the range of about 20 wt % to about 80 wt %, based on the total weight of the barrier mixture. For example, in certain embodiments, ethylene vinyl alcohol copolymer can be present in the barrier mixture in an amount in the range of about 20 wt % to about 70 wt %, or about 20 wt % to about 65 wt %, or about 20 wt % to about 60 wt %, or about 20 wt % to about 55 wt %, or about 20 wt % to about 50 wt %, or about 20 wt % to about 40 wt %, or about 35 wt % to about 80 wt %, or about 35 wt % to about 70 wt %, or about 35 wt % to about 65 wt %, or about 35 wt % to about 60 wt %, or about 35 wt % to about 55 wt %, or about 35 wt % to about 50 wt %, or about 35 wt % to about 40 wt %, or about 50 wt % to about 80 wt %, or about 50 wt % to about 70 wt %, or about 50 wt % to about 65 wt %, or about 50 wt % to about 60 wt %, or about 50 wt % to about 55 wt %, or about 65 wt % to about 80 wt %, or about 65 wt % to about 70 wt %, or about 60 wt % to about 80 wt %, or about 60 wt % to about 75 wt %, or about 60 wt % to about 70 wt %, or about 70 wt % to about 80 wt %, or about 45 wt % to about 55 wt %, or about 47 wt % to about 53 wt %, or about 48 wt % to about 52 wt %, based on the total weight of the barrier mixture.

As noted above, the barrier mixture also comprises one or more fluoropolymers. A variety of fluoropolymer materials can be used as the fluoropolymer of the barrier layer. In certain especially desirable embodiments, the fluoropolymer is a polymer or copolymer having monomeric residues having free radical-abstractable hydrogen atoms.

For example, in certain embodiments of the tubings as otherwise described herein, the fluoropolymer is at least 75 wt % (e.g., at least 90 wt %, or consists essentially of) a PVDF polymer. A PVDF polymer, as used herein, is a polymer having at least 40 mol % (e.g., at least 50 mol %) vinylidene difluoride residues. Thus, the PVDF polymer can be a homopolymerize of vinylidene difluoride, or a copolymer of vinylidene difluoride with additional monomer(s). In certain desirable embodiments, such copolymers have at least 75 wt %, at least 90 wt % or even consist essentially of fluorinated monomeric subunits. Desirable PVDF copolymers include, for example, the copolymers of vinylidene difluoride and trifluoroethylene, usually in ratios of about 50:50 wt % and 65:35 wt % (equivalent to about 56:44 mol % and 70:30 mol %) and vinylidene difluoride and tetrafluoroethylene and vinylidene difluoride and hexafluoropropylene (HFP). Commercially available vinylidene difluoride-containing fluoropolymers include, for example, those fluoropolymers having the trade designations; “KYNAR” (e.g., “KYNAR 740”, “KYNARFLEX 2500” AND “KYNARFLEX 2750”) as marketed by Arkema; “HYLAR” (e.g., “HYLAR 700”) as marketed by Solvay Solexis, Morristown, N.J.; and “FLUOREL” (e.g., “FLUOREL FC-2178”) as marketed by Dyneon, LLC. Other examples include PVDF-HFP copolymers available under the trade designation “ULTRAFLEX B.”

In certain other embodiments of the tubings as otherwise described herein, the fluoropolymer is at least 75 wt % (e.g., at least 90 wt %, or consists essentially of) a CPT polymer. As used herein, the person of ordinary skill in the art will appreciate that “at least 75% of a CPT polymer” includes use of a plurality of CPT polymers in a total amount of at least 75%; analogous statements related other amounts and other polymers will be understood similarly. CPT, as used herein, is a copolymer of chlorotrifluoroethylene (CTFE), tetrafluoroethylene (TFE), and perfluoro(alkyl vinyl ether) (PFA). In certain desirable embodiments, such copolymers have at least 75 wt %, at least 90 wt % or even consist essentially of fluorinated monomeric subunits. Desirable CPT copolymers include, for example, the copolymers of CTFE, TFE, and PFA. Commercially available CPT fluoropolymers include, for example, those fluoropolymers having the trade designations; “NEOFLON” (e.g., “NEOFLON™ CPT LP-Series” as marketed by Daikin Industries, Ltd. Other examples include copolymers as described in U.S. Patent Publication No. 2007/0219333 and U.S. Pat. No. 8,530,014, both incorporated herein in their entirety.

Other fluorinated materials can be used in the tubings of the disclosure. For example, in certain embodiments of the tubings as otherwise described herein, the fluoropolymer of the barrier layer include a fluorinated ethylene propylene copolymer (“a FEP polymer”), a copolymer of tetrafluoroethylene and perfluoropropyl vinyl ether (“a PFA polymer”), a copolymer of tetrafluoroethylene and perfluoromethyl vinyl ether (“a MFA polymer”), a copolymer of ethylene and tetrafluoroethylene (“an ETFE polymer”), copolymer of ethylene, tetrafluoroethylene, and hexafluoropropylene (“an EFEP polymer”), a copolymer of ethylene and chlorotrifluoroethylene (“an ECTFE polymer”), polychlorotrifluoroethylene (“a PCTFE polymer”), a terpolymer including tetrafluoroethylene, hexafluoropropylene, and vinylidenefluoride (“a THV polymer”), or a combination or copolymer thereof. And the person of ordinary skill in the art will understand that other fluorinated polymers can be used; desirably, the polymer has at least 75 mol %, at least 90 mol %, or even at least 95 mol % fluorinated monomer residues.

And in certain embodiments as otherwise described herein, a barrier layer can include a minor amount (e.g., no more than 25 wt %) of other polymer (i.e., not fluoropolymer) that has free radical-abstractable hydrogen atoms. Desirably, such polymer is miscible with, or otherwise compatible with the fluoropolymer.

The one or more fluoropolymers can be present in the barrier mixture in an amount in the range of about 20 wt % to about 80 wt %, based on the total weight of the barrier mixture. For example, in certain embodiments, the one or more fluoropolymers can be present in the barrier mixture in an amount in the range of about 20 wt % to about 70 wt %, or about 20 wt % to about 65 wt %, or about 20 wt % to about 60 wt %, or about 20 wt % to about 55 wt %, or about 20 wt % to about 50 wt %, or about 20 wt % to about 40 wt %, or about 35 wt % to about 80 wt %, or about 35 wt % to about 70 wt %, or about 35 wt % to about 65 wt %, or about 35 wt % to about 60 wt %, or about 35 wt % to about 55 wt %, or about 35 wt % to about 50 wt %, or about 35 wt % to about 40 wt %, or about 50 wt % to about 80 wt %, or about 50 wt % to about 70 wt %, or about 50 wt % to about 65 wt %, or about 50 wt % to about 60 wt %, or about 50 wt % to about 55 wt %, or about 65 wt % to about 80 wt %, or about 65 wt % to about 70 wt %, or about 60 wt % to about 80 wt %, or about 60 wt % to about 75 wt %, or about 60 wt % to about 70 wt %, or about 70 wt % to about 80 wt %, or about 45 wt % to about 55 wt %, or about 47 wt % to about 53 wt %, or about 48 wt % to about 52 wt %, all based on the total weight of the barrier mixture.

In certain embodiments, ethylene vinyl alcohol copolymer is present in the barrier mixture in an amount in the range of about 20 wt % to about 80 wt %, and the one or more fluoropolymers are present in the barrier mixture in an amount in the range of about 20 wt % to about 80 wt %, all based on the total weight of the barrier mixture.

In certain embodiments, ethylene vinyl alcohol copolymer is present in the barrier mixture in an amount in the range of about 30 wt % to about 70 wt %, and the one or more fluoropolymers are present in the barrier mixture in an amount in the range of about 30 wt % to about 70 wt %, all based on the total weight of the barrier mixture.

In certain exemplary embodiments, ethylene vinyl alcohol copolymer is present in the barrier mixture in an amount in the range of about 45 wt % to about 55 wt %, and the one or more fluoropolymers are present in the barrier mixture in an amount in the range of about 45 wt % to about 55 wt %, all based on the total weight of the barrier mixture.

Ethylene vinyl alcohol copolymer and the one or more fluoropolymers may be present in various ratios. Thus, in certain embodiments, the ratio of ethylene vinyl alcohol copolymer and the one or more fluoropolymers in the barrier mixture is about 1:3 to about 3:1, e.g., about 1:2 to about 2:1; or about 1:1.5 to about 1.5:1; about 1:1.1 to about 1.1:1; or about 1:3 to about 1:1, or about 1:2 to about 1:1; or about 1:1.5 to about 1:1; about 1:1.1 to about 1:1; about 1:1 to about 3:1, or about 1:1 to about 2:1; or about 1:1 to about 1.5:1; about 1:1 to about 1.1:1.

The barrier mixture of the disclosure may further comprise one or more compatibilizers. A variety of compatibilizers are known in the art and may be selected based on the disclosure herein, balance material properties and cost, among other factors, to provide a desired blend of EVOH and the fluoropolymer(s). Some suitable compatibilizers include, but are not limited to, a maleic anhydride functionalized fluoropolymer (e.g., PVDF-MA), an anhydride functionalized fluoropolymer, an anhydride functionalized polyethylene, an glycidyl methacrylate functionalized olefin, and a combination or copolymer thereof. In certain embodiments, the compatibilizer is PVDF-MA.

The one or more compatibilizers can be present in the barrier mixture in an amount in the range of about 0.01 wt % to about 10 wt %, based on the total weight of the barrier mixture. For example, in certain embodiments, the one or more compatibilizers can be present in the barrier mixture in an amount in the range of about 0.1 wt % to about 10 wt %, or about 0.1 wt % to about 5 wt %, or about 0.1 wt % to about 2 wt %, or about 0.1 wt % to about 1 wt %, or about 1 wt % to about 10 wt %, or about 1 wt % to about 5 wt %, or about 1 wt % to about 2 wt %, about 2 wt % to about 10 wt %, or about 2 wt % to about 5 wt %, or about 5 wt % to about 10 wt %, all based on the total weight of the barrier mixture.

In certain embodiments, the barrier mixture of the disclosure is essentially free of the compatibilizers.

The barrier layer can be formed in variety of thicknesses. The person of ordinary skill in the art will, based on the disclosure herein, balance material properties and cost, among other factors, to provide a desired thickness of the barrier layer. In certain embodiments of the tubings as otherwise described herein, the barrier layer has a thickness in the range of about 0.010 mm to about 20 mm.

While the barrier layer can be formed in variety of thicknesses, the inventors have unexpectedly found that the barrier layers of no more than 0.200 mm in thickness afford significant cost savings yet meet the necessary permeance of fuel vapors standards. The person of ordinary skill in the art will, based on the disclosure herein, balance material properties, fuel vapor permeance properties and cost, among other factors, to provide a desired thickness of the barrier layer. In certain embodiments of the tubings as otherwise described herein, the barrier layer has a thickness in the range of about 0.010 mm to about 0.200 mm. For example, the barrier layer has a thickness in the range of about 0.010 mm to about 0.150 mm, or about 0.010 mm to about 0.130 mm, or about 0.010 mm to about 0.100 mm, or about 0.010 mm to about 0.075 mm, or about 0.030 mm to about 0.200 mm, or about 0.030 mm to about 0.150 mm, or about 0.030 mm to about 0.130 mm, or about 0.030 mm to about 0.100 mm, or about 0.030 mm to about 0.075 mm, or about 0.050 mm to about 0.200 mm, or about 0.050 mm to about 0.150 mm, or about 0.050 mm to about 0.130 mm, or about 0.050 mm to about 0.100 mm, or about 0.050 mm to about 0.075 mm, or about 0.100 mm to about 0.200 mm, or about 0.100 mm to about 0.150 mm, or about 0.100 mm to about 0.130 mm, or about 0.150 mm to about 0.200 mm, or about 0.170 mm to about 0.200 mm. The fuel vapor permeance will be a function of layer thickness, and the thickness needed to provide a particular desired permeance will depend on the identity of the barrier mixture.

In certain other embodiments, the barrier layer has a thickness in the range of about 0.2 mm to about 20 mm, or about 0.2 mm to about 15 mm, or about 0.2 mm to about 13 mm, or about 0.2 mm to about 10 mm, or about 0.2 mm to about 5 mm, or about 0.2 mm to about 2 mm, or about 0.5 mm to about 20 mm, or about 0.5 mm to about 15 mm, or about 0.5 mm to about 13 mm, or about 0.5 mm to about 10 mm, or about 0.5 mm to about 5 mm, or about 0.5 mm to about 2 mm, or about 1 mm to about 20 mm, or about 1 mm to about 15 mm, or about 1 mm to about 13 mm, or about 1 mm to about 10 mm, or about 1 mm to about 5 mm, or about 1 mm to about 2 mm, or about 5 mm to about 20 mm, or about 5 mm to about 15 mm, or about 5 mm to about 13 mm, or about 5 mm to about 10 mm, or about 10 mm to about 20 mm, or about 10 mm to about 15 mm.

As described above, the tubings of the disclosure can be configured to further include one or more inner annular support layers. Such an embodiment is shown in the schematic views of FIGS. 2-4, discussed above. A variety of support layer materials known to those of skill in the art may be used.

In certain embodiments, the support layer is formed from at least 75 wt % thermoplastic polyurethane. In certain embodiments of the tubings as otherwise described herein, the support layer is formed from at least 80 wt % thermoplastic polyurethane, or at least 85 wt % thermoplastic polyurethane, or at least 90 wt % thermoplastic polyurethane, or at least 95 wt % thermoplastic polyurethane, or even at least 98 wt % thermoplastic polyurethane. In other embodiments as otherwise described herein, the support layer consists essentially of thermoplastic polyurethane.

A variety of thermoplastic polyurethane materials can be used as the thermoplastic polyurethane material of the support layer. The person of ordinary skill in the art will appreciate that there are a variety of thermoplastic polyurethane materials that provide desired mechanical properties to a tubing and are amenable to formation into tubings by extrusion. The person of ordinary skill in the art will, based on the present disclosure, select an appropriate thermoplastic polyurethane to provide any other desirable properties, for example, adequate fuel/chemical resistance, flexibility, a low glass transition temperature (e.g., using a soft-segment phase) for low temperature applications, adequate weatherability/UV resistance, and adequate mechanical strength to withstand installation, to maintain fitting retention, and to maintain a seal in use.

Typically, a thermoplastic polyurethane is formed by reacting a polyol with an isocyanate. As the person of ordinary skill in the art will appreciate, the overall properties of the polyurethane will depend, among other things, upon the type of polyol and isocyanate, crystallinity in the polyurethane, the molecular weight of the polyurethane and chemical structure of the polyurethane backbone. Many typical thermoplastic polyurethanes also include a chain extender such as 1,4-butanediol that can form hard segment blocks in the polymer chain. Polyurethanes can generally be classified as being either thermoplastic or thermoset, depending on the degree of crosslinking present. Thermoplastic urethanes do not have primary crosslinking while thermoset polyurethanes have a varying degree of crosslinking, depending on the functionality of the reactants. As used herein, a “thermoplastic polyurethane” is one in which at least 95 mol %, at least 99 mol %, or even substantially all of its polyol constituent is difunctional. As described in more detail below, such materials can be crosslinked by electron beam treatment; despite such crosslinking, the present disclosure considers such materials “thermoplastic.”

Thermoplastic polyurethanes are commonly based on either methylene diisocyanate or toluene diisocyanate and include both polyester and polyether grades of polyols. Thermoplastic polyurethanes can be formed by a “one-shot” reaction between isocyanate and polyol (e.g., with optional chain extender) or by a “pre-polymer” system, wherein a curative is added to the partially reacted polyolisocyanate complex to complete the polyurethane reaction. Examples of some common thermoplastic polyurethane elastomers based on “pre-polymers” are “TEXIN”, a tradename of Bayer Materials Science, “ESTANE”, a tradename of Lubrizol, “PELLETHANE”, a tradename of Lubirzol, and “ELASTOLLAN”, a tradename of BASF.

In certain embodiments of the tubings as described herein, the support layer is a polyether-type thermoplastic polyurethane, a polyester-type thermoplastic polyurethane, or a combination or copolymer thereof. Typically, thermoplastic polyurethanes used in fuel tubings are ester-type thermoplastic polyurethanes. Ester-type thermoplastic polyurethanes can be based on different compositions of substituted or unsubstituted methane diisocyanate (MDI) and a substituted or unsubstituted dihydroxy alcohol (a glycol).

In certain advantageous embodiments of the tubings as otherwise described herein, the thermoplastic polyurethane of the support layer is a polyether-type polyurethane. Polyether-type thermoplastic polyurethanes can be more resistant to hydrolytic degradation than polyester-type thermoplastic polyurethanes. But the fact that they generally have lower resistance to hydrocarbons makes polyether-type thermoplastic polyurethanes generally less suitable than polyester-type polyurethanes for use in conventional fuel tubings. But the softness of some grades of polyether-type thermoplastic polyurethanes can make them more suitable for use in tubings like those described here.

Of course, in other embodiments, the support layer can be formed from other non-fluorinated thermoplastic polymers. Examples of other examples of materials that can be suitable for use in support layers include, for example, polyamide resins, polyester resins, ethylene acrylic acid and methacrylic acid copolymer resins, polyolefin resins, vinyl chloride-based resins, polyurethane resins, polyaramid resins, polyimide resins, polyamideimide resins, polyphenylene oxide resins, polyacetal resins, polyetheretherketone resins (PEEK), polysulfone resins, polyethersulfone resins (PES), polyetherimide resins, ethylene/vinyl alcohol copolymer-based resins, polyphenylene sulfide resins, polybutylene naphthalate resins, polybutylene terephthalate resins, polyphthalamides (PPA), polyphenylene sulfide (PPS), and a combination or copolymer thereof.

The support layer can be formed in variety of thicknesses. The person of ordinary skill in the art will, based on the disclosure herein, balance material properties and cost, among other factors, to provide a desired thickness of the support layer. In certain embodiments of the tubings as otherwise described herein, the support layer has a thickness in the range of about 0.5 mm to about 20 mm. For example, in various embodiments as otherwise described herein, the support layer has a thickness in the range of or 0.5 mm to 10 mm, or 0.5 mm to 5 mm, or 0.5 mm to 3 mm, or 0.5 mm to 2 mm, or 1 mm to 20 mm, or 1 mm to 10 mm, or 1 mm to 5 mm, or 1 mm to 3 mm, or 2 mm to 20 mm, or 2 mm to 10 mm, or 2 mm to 7 mm, or 2 mm to 5 mm, or 5 mm to 20 mm, or 5 mm to 15 mm, or 5 mm to 10 mm, or 10 mm to 20 mm.

In certain embodiments, the material volume of the tubing is at least 50%, at least 70%, at least 90%, or even at least 95% made up of the support layer and the barrier layer.

Notably, the tubings of the disclosure do not require coupling agents or adhesive layers to adhere the support layer to the barrier layer or to the tie layer, which even layer contacts the inner surface of the support layer.

As described above, the tubings of the disclosure can be configured to further include one or more inner annular polymer or tie layers disposed on the surface of the barrier layer. Such an embodiment is shown in the cross-sectional schematic view of FIGS. 3 and 4, discussed above. A variety of polymeric materials can be used as the polymer or tie layer. In certain embodiments, this layer is formed from at least 75 wt % fluorine-free polymer. For example, in certain embodiments, the polymer or tie layer is formed from at least 80 wt % fluorine-free polymer, or at least 85 wt % fluorine-free polymer, or at least 90 wt % fluorine-free polymer, or at least 95 wt % fluorine-free polymer, or even at least 98 wt % fluorine-free polymer. In certain embodiments, the polymer or tie layer consists essentially of fluorine-free polymer. The person of ordinary skill in the art will appreciate that a variety of fluorine-free polymers can be suitable for use in the tubings described herein. For example, the fluorine-free polymer is selected from polyamide resins, polyester resins, ethylene acrylic acid and methacrylic acid copolymer resins, polyolefin resins, vinyl chloride-based resins, polyurethane resins, polyaramid resins, polyimide resins, polyamideimide resins, polyphenylene oxide resins, polyacetal resins, polyetheretherketone resins (PEEK), polysulfone resins, polyethersulfone resins (PES), polyetherimide resins, ethylene/vinyl alcohol copolymer-based resins, polyphenylene sulfide resins, polybutylene naphthalate resins, polybutylene terephthalate resins, polyphthalamides (PPA), polyphenylene sulfide (PPS), and a combination or copolymer thereof. In certain desirable embodiments, the fluorine-free polymer is a polyamide resin.

As the person of ordinary skill in the art would appreciate, a number of other additives may be present in the layers, such as leftover polymerization agent (i.e., from the polymerizations of the thermoplastic polyurethane and/or the fluoropolymer), antioxidants, flame retardants, acid scavengers, anti-static agents and processing aids such as melt flow index enhancers.

The polymer or tie layer can be formed in variety of thicknesses. In certain embodiments of the tubings as otherwise described herein, the polymer or tie has a thickness in the range of about 0.010 mm to about 20 mm. For example, the polymer or tie layer has a thickness in the range of about 0.010 mm to about 0.150 mm, or about 0.010 mm to about 0.130 mm, or about 0.010 mm to about 0.100 mm, or about 0.010 mm to about 0.075 mm, or about 0.030 mm to about 0.200 mm, or about 0.030 mm to about 0.150 mm, or about 0.030 mm to about 0.130 mm, or about 0.030 mm to about 0.100 mm, or about 0.030 mm to about 0.075 mm, or about 0.050 mm to about 0.200 mm, or about 0.050 mm to about 0.150 mm, or about 0.050 mm to about 0.130 mm, or about 0.050 mm to about 0.100 mm, or about 0.050 mm to about 0.075 mm, or about 0.100 mm to about 0.200 mm, or about 0.100 mm to about 0.150 mm, or about 0.100 mm to about 0.130 mm, or about 0.150 mm to about 0.200 mm, or about 0.170 mm to about 0.200 mm. In certain other embodiments, the polymer or tie layer has a thickness in the range of about 0.2 mm to about 20 mm, or about 0.2 mm to about 15 mm, or about 0.2 mm to about 13 mm, or about 0.2 mm to about 10 mm, or about 0.2 mm to about 5 mm, or about 0.2 mm to about 2 mm, or about 0.5 mm to about 20 mm, or about 0.5 mm to about 15 mm, or about 0.5 mm to about 13 mm, or about 0.5 mm to about 10 mm, or about 0.5 mm to about 5 mm, or about 0.5 mm to about 2 mm, or about 1 mm to about 20 mm, or about 1 mm to about 15 mm, or about 1 mm to about 13 mm, or about 1 mm to about 10 mm, or about 1 mm to about 5 mm, or about 1 mm to about 2 mm, or about 5 mm to about 20 mm, or about 5 mm to about 15 mm, or about 5 mm to about 13 mm, or about 5 mm to about 10 mm, or about 10 mm to about 20 mm, or about 10 mm to about 15 mm.

The tubings of the present disclosure can be made in a wide variety of lengths. In certain embodiments, the length of a length of flexible tubing as otherwise described herein is at least 5 cm. In various embodiments as otherwise described herein, the length of the length of flexible tubing is at least 10 cm, at least 20 cm, at least 30 cm, or even at least 50 cm. In various embodiments as otherwise described herein, the length of the length of flexible tubing is at least 1 m, at least 2 m, at least 3 m, at least 5 m, or even at least 10 m.

The tubings of the present disclosure can be made in a variety of sizes. For example, in certain embodiments of the tubings as otherwise described herein, the inner diameter of the annular cross-section is in the range of 0.5 mm to 40 mm. In various particular embodiments of the flexible tubing as otherwise described herein, the inner diameter of the annular cross-section is in the range of 0.5 mm to 30 mm, or 0.5 mm to 20 mm, or 0.5 mm to 15 mm, or 0.5 mm to 10 mm, or 0.5 mm to 5 mm, or 1 mm to 40 mm, or 1 mm to 30 mm, or 1 mm to 20 mm, or 1 mm to 15 mm, or 1 mm to 10 mm, or 5 mm to 40 mm, or 5 mm to 30 mm, or 5 mm to 20 mm, or 5 mm to 15 mm, or 5 mm to 10 mm, or 10 mm to 40 mm, or 10 mm to 30 mm, or 10 mm to 20 mm. Similarly, in certain embodiments of the tubings as otherwise described herein, the wall thickness of the annular cross-section is in the range of 0.5 mm to 25 mm. In various particular embodiments of the flexible tubing as otherwise described herein, the wall thickness of the annular cross-section is in the range of 0.5 mm to 15 mm, or 0.5 mm to 10 mm, or 0.5 mm to 8 mm, or 0.5 mm to 5 mm, or 0.5 mm to 3 mm, or 0.5 mm to 2 mm, or 1 mm to 25 mm, or 1 mm to 15 mm, or 1 mm to 10 mm, or 1 mm to 8 mm, or 1 mm to 5 mm, or 1 mm to 3 mm, or 2 mm to 25 mm, or 2 mm to 15 mm, or 2 mm to 10 mm, or 2 mm to 8 mm, or 2 mm to 5 mm, or 5 mm to 25 mm, or 5 mm to 15 mm, or 5 mm to 10 mm, or 5 mm to 8 mm, or 10 mm to 25 mm, or 10 mm to 15 mm, or 15 mm to 25 mm.

The description of the tubings herein imply an interface between the layers, (i.e., at the outer surface of the barrier layer and the inner surface of the support layer; or the outer surface of the barrier layer and the inner surface of the polymer or tie layer; etc.). As the person of ordinary skill in the art will appreciate, in many real-world samples there will be some intermingling of the materials at the interface. The person of ordinary skill in the art will nonetheless be able to discern where one layer ends and the other begins.

The person of ordinary skill in the art can otherwise prepare the tubings of the disclosure using conventional methods. For example, in certain embodiments, the length of tubing is formed by co-extruding the various layers (e.g., the barrier layer with the support layer and/or polymer layer). Conventional extrusion methods, such as those described in U.S. Pat. Nos. 7,866,348 and 8,092,881, can be used to provide the length of flexible tubing.

In certain embodiments, the contact of the outer surface of the barrier layer and the inner surface of the support layer is affected by treatment with an electron beam.

The use of a barrier layer comprising a blend of EVOH and one or more fluoropolymners can provide the tubings described herein with excellent resistance to permeation of hydrocarbon fuel vapor. For example, in certain embodiments as otherwise described herein, the tubing has a permeation rating of no more than 15 g/m²/day, e.g., no more than 10 g/m²/day, 7 g/m²/day, or 5 g/m²/day, for CE10 at 40° C. using test SAE J1737 method. In certain other embodiments as otherwise described herein, the tubing (e.g., such as tubing for use in marine applications) has a permeation rating of no more than 5 g/m²/day, e.g., no more than 4.9 g/m²/day, 4.5 g/m²/day, or 4 g/m²/day, for CE10 at 40° C. using test SAE J1527 conditions.

The flexible tubings as described herein are especially useful in the transmission of hydrocarbon fuels. Accordingly, another aspect of the disclosure is a method for transmitting a hydrocarbon fuel, including providing a flexible tubing as described herein, and flowing the hydrocarbon fuel through the tubing from a first end to a second end thereof. A wide variety of hydrocarbon fuels can be used with the tubings of the disclosure, e.g., gasoline, diesel fuel, kerosene.

The tubings described herein can be used to transfer gasoline and other hydrocarbon fuels in engines, such as non-automotive engines. The present disclosure provides a low-permeation design which can be configured to meet the permeation performance requirements of US EPA that requires particularly stringent permeation performance. Thus, another aspect of the disclosure is a fuel-powered device comprising a fuel tank, a fuel-powered engine, and a length of tubing of the present disclosure fluidly connecting the fuel tank with the fuel-powered engine (i.e., configured so as to transmit fuel from the fuel tank to the engine). The engine can be a marine device, such as a boat, or a jet-ski. The engine can be a hand-operated device, such as a lawn tractor, a string trimmer, a leafblower, a snowblower, a lawnmower, a tiller, or a chain saw. The engine can also be an automotive device, such as an automobile, a motorcycle, or a 4-wheel or other recreational vehicles.

Various aspects of the tubings and methods of the disclosure are further described with respect to the non-limiting examples described below.

### EXAMPLES 1-10

The polymers were melt compounded, pelletized, and subsequently coextruded into 0.005″ (˜0.127 mm) films. The specific weight and types of polymers used in each example are provided in Table 1. Also, differential scanning calorimetry (DSC) was conducted on the pellets prior to extrusion. The DSC scans show distinct melting and crystallization peaks for the PVDF copolymers and EVOH, which consistent with a two-phase morphology.

TABLE 1

| | | EVOH | | Fluoro- |
|---|---|---|---|---|
| Example No. | EVOH | wt % | fluoropolymer | polymer wt % |
| Comp. Ex. 1 | EVAL ™ XEP-1158^{a} | 100 | — | 0 |
| 2 | EVAL ™ XEP-1158 | 65 | KYNAR ADX 1285^{b} | 35 |
| 3 | EVAL ™ XEP-1158 | 50 | KYNAR ADX 1285 | 50 |
| 4 | EVAL ™ XEP-1158 | 35 | KYNAR ADX 1285 | 65 |
| Comp. Ex. 5 | — | 0 | KYNAR ADX 1285 | 100 |
| 6 | EVAL ™ XEP-1158 | 62.5 | KYNAR Superflex 2500^{c} | 32.5 |
| | | | KYNAR ADX 1285 | 5 |
| 7 | EVAL ™ XEP-1158 | 47.5 | KYNAR Superflex 2500 | 47.5 |
| | | | KYNAR ADX 1285 | 5 |
| 8 | EVAL ™ XEP-1158 | 32.5 | KYNAR Superflex 2500 | 62.5 |
| | | | KYNAR ADX 1285 | 5 |
| 9 | EVAL ™ XEP-1158 | 65 | KYNAR Superflex 2500 | 35 |
| Comp. Ex. 10 | — | 0 | KYNAR Superflex 2500 | 100 |

^{a}EVAL ™ XEP-1158 is 44 mol % etylene
^{b}KYNAR ADX 1285 is a PVDF copolymer of vinylidene difluoride and hexafluoropropylene, functionalized with maleic anhydride (1 mol % or less functionalization)
^{c}KYNAR Superflex 2500 is a PVDF copolymer of vinylidene difluoride and hexafluoropropylene.

The films made from the polymers of Examples 1-10 were then tested for tensile properties and fuel permeation The permeation was measured using the following test method: A permeation jar having a glass body and a lid with an opening in the top was used. The top of the lid of the permeation jar was traced onto the film sample (0.005″ in thickness), and the sample was cut out along the trace and fitted into the lid of the jar. 30 mL of CE 10 fuel (recipe, 450 mL toluene, 450 mL isooctane, 10 mL ethanol) was added to the jar, and the lid with the sample was screwed on. An initial mass of the jar (i.e., together with the lid, fuel and sample) was recorded, and the jar was placed in a fireproof oven at 43° C. The jar was removed from the oven and reweighed after a week. The permeation loss in g·m/m²/day was calculated using the following equation:

$$\frac{( final mass - initial mass ) ( thickness )}{( film area ) ( time )}$$

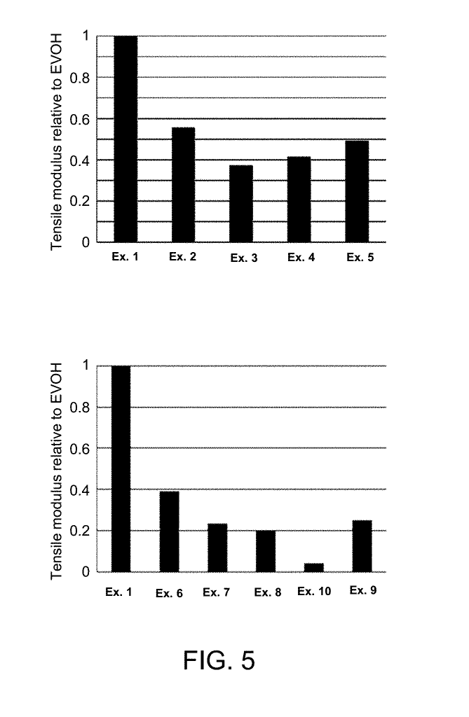

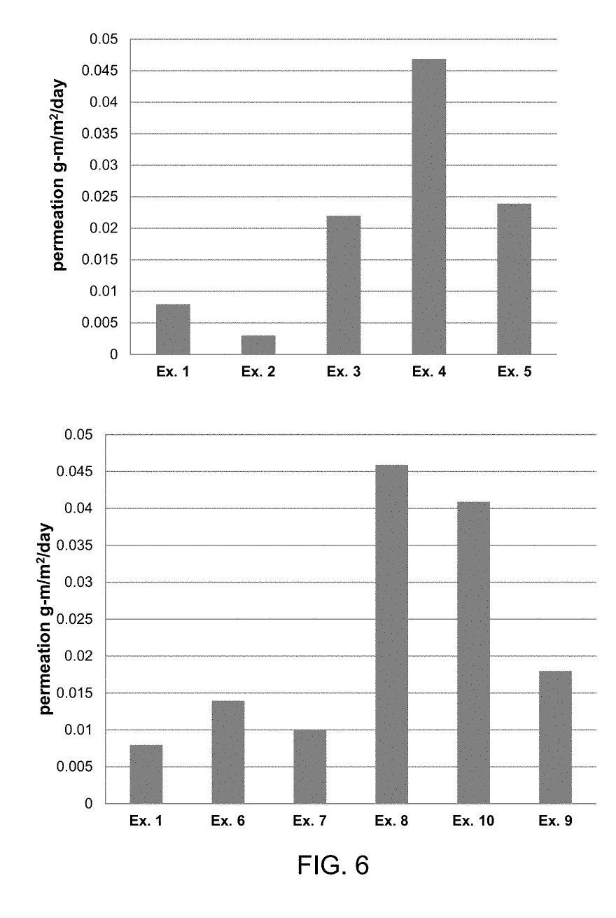

The results are provided in FIGS. 5 (tensile properites) and 6 (fuel permeation). As provided in FIG. 5, the tensile modulus results indicate that the blends have reduced modulus relative to the neat EVOH example. For example, the blend of Ex. 7 had a tensile modulus 20% of that of the neat EVOH example. In addition, as shown in FIG. 6 the blends were able to maintain low permeation, similar to that of the neat EVOH example, such as the blend of Ex. 7. At higher loadings of the PVDF copolymer, permeation increased relative to that of the neat EVOH example.

Overall, these initial results indicate that a barrier layer made from a blend of EVOH and fluoropolymer (e.g. PVDF) provides a balance of modulus and permeation that is more favorable compared to neat EVOH or the fluoropolymer. In addition, the blends would have a lower raw material cost compared to neat PVDF, but provide the barrier layer with the flexibility of PVDF.

Additional aspects of the disclosure are provided by the following numbered embodiments, which can be combined and permuted in any number and in any fashion that is not logically or technically inconsistent.
Embodiment 1. A length of tubing having an annular cross-section, the annular cross-section having an inner surface and an outer surface, the annular cross-section comprising:
   an annular barrier layer formed from a barrier mixture comprising ethylene vinyl alcohol copolymer and one or more fluoropolymers, wherein the combined content of ethylene vinyl alcohol copolymer and the one or more fluoropolymers in the barrier mixture is in an amount of at least 75 wt %, and the barrier layer having an outer surface and an inner surface.
Embodiment 2. The length of tubing of embodiment 1, wherein ethylene vinyl alcohol copolymer is present in the barrier mixture in an amount in the range of about 20 wt % to about 80 wt %; e.g., in the range of about 20 wt % to about 70 wt %, or about 20 wt % to about 65 wt %, or about 20 wt % to about 60 wt %, or about 20 wt % to about 55 wt %, or about 20 wt % to about 50 wt %, or about 20 wt % to about 40 wt %.
Embodiment 3. The length of tubing of embodiment 1, wherein ethylene vinyl alcohol copolymer is present in the barrier mixture in an amount in the range of about 35 wt % to about 80 wt %, e.g., or about 35 wt % to about 70 wt %, or about 35 wt % to about 65 wt %, or about 35 wt % to about 60 wt %, or about 35 wt % to about 55 wt %, or about 35 wt % to about 50 wt %, or about 35 wt % to about 40 wt %.
Embodiment 4. The length of tubing of embodiment 1, wherein ethylene vinyl alcohol copolymer is present in the barrier mixture in an amount in the range of about 50 wt % to about 80 wt %, or about 50 wt % to about 70 wt %, or about 50 wt % to about 65 wt %, or about 50 wt % to about 60 wt %, or about 50 wt % to about 55 wt %.
Embodiment 5. The length of tubing of embodiment 1, wherein ethylene vinyl alcohol copolymer is present in the barrier mixture in an amount in the range of about 65 wt % to about 80 wt %, or about 65 wt % to about 70 wt %, or about 60 wt % to about 80 wt %, or about 60 wt % to about 75 wt %, or about 60 wt % to about 70 wt %, or about 70 wt % to about 80 wt %, or about 45 wt % to about 55 wt %, or about 47 wt % to about 53 wt %, or about 48 wt % to about 52 wt %.
Embodiment 6. The length of tubing of any of embodiments 1-5, wherein the one or more fluoropolymers comprises a PVDF polymer, a CPT polymer, a FEP polymer, a PEA polymer, an ETFE polymer, an EFEP polymer, an ECTFE polymer, a PCTFE polymer, a THV polymer, or a combination or copolymer thereof.
Embodiment 7. The length of tubing of any of embodiments 1-5, wherein the one or more fluoropolymers is a PVDF polymer.
Embodiment 8. The length of tubing of any of embodiments 1-7, wherein the one or more fluoropolymers is present in the barrier mixture in an amount in the range of about 20 wt % to about 80 wt %; e.g., in the range of about 20 wt % to about 70 wt %, or about 20 wt % to about 65 wt %, or about 20 wt % to about 60 wt %, or about 20 wt % to about 55 wt %, or about 20 wt % to about 50 wt %, or about 20 wt % to about 40 wt %.
Embodiment 9. The length of tubing of any of embodiments 1-7, wherein the one or more fluoropolymers is present in the barrier mixture in an amount in the range of about 35 wt % to about 80 wt %, or about 35 wt % to about 70 wt %, or about 35 wt % to about 65 wt %, or about 35 wt % to about 60 wt %, or about 35 wt % to about 55 wt %, or about 35 wt % to about 50 wt %, or about 35 wt % to about 40 wt %.
Embodiment 10. The length of tubing of any of embodiments 1-7, wherein the one or more fluoropolymers is present in the barrier mixture in an amount in the range of about 50 wt % to about 80 wt %, or about 50 wt % to about 70 wt %, or about 50 wt % to about 65 wt %, or about 50 wt % to about 60 wt %, or about 50 wt % to about 55 wt %, or about 65 wt % to about 80 wt %.
Embodiment 11. The length of tubing of any of embodiments 1-7, wherein the one or more fluoropolymers is present in the barrier mixture in an amount in the range of about 65 wt % to about 70 wt %, or about 60 wt % to about 80 wt %, or about 60 wt % to about 75 wt %, or about 60 wt % to about 70 wt %, or about 70 wt % to about 80 wt %, or about 45 wt % to about 55 wt %, or about 47 wt % to about 53 wt %, or about 48 wt % to about 52 wt %.
Embodiment 12. The length of tubing of any of embodiments 1-11, wherein ethylene vinyl alcohol copolymer is present in the barrier mixture in an amount in the range of about 20 wt % to about 80 wt %, and the one or more fluoropolymers are present in the barrier mixture in an amount in the range of about 20 wt % to about 80 wt %.
Embodiment 13. The length of tubing of any of embodiments 1-11, wherein ethylene vinyl alcohol copolymer is present in the barrier mixture in an amount in the range of about 30 wt % to about 70 wt %, and the one or more fluoropolymers are present in the barrier mixture in an amount in the range of about 30 wt % to about 70 wt %.
Embodiment 14. The length of tubing of any of embodiments 1-11, wherein ethylene vinyl alcohol copolymer is present in the barrier mixture in an amount in the range of about 45 wt % to about 55 wt %, and the one or more fluoropolymers are present in the barrier mixture in an amount in the range of about 45 wt % to about 55 wt %.
Embodiment 15. The length of tubing of any of embodiments 1-14, wherein the combined content of ethylene vinyl alcohol copolymer and the one or more fluoropolymers in the barrier mixture is in an amount of at least 80 wt %, e.g., at least 85 wt %, or at least 90 wt %, based on the total weight of the barrier mixture.
Embodiment 16. The length of tubing of any of embodiments 1-14, wherein the combined content of ethylene vinyl alcohol copolymer and the one or more fluoropolymers in the barrier mixture is in an amount of at least 95 wt %, e.g., at least 98 wt %, based on the total weight of the barrier mixture.
Embodiment 17. The length of tubing of any of embodiments 1-16, wherein the ratio of ethylene vinyl alcohol copolymer and the one or more fluoropolymers in the barrier mixture is about 1:3 to about 3:1, e.g., about 1:2 to about 2:1; or about 1:1.5 to about 1.5:1; about 1:1.1 to about 1.1:1.
Embodiment 18. The length of tubing of any of embodiments 1-16, wherein the ratio of ethylene vinyl alcohol copolymer and the one or more fluoropolymers in the barrier mixture is about 1:3 to about 1:1, e.g., about 1:2 to about 1:1; or about 1:1.5 to about 1:1; about 1:1.1 to about 1:1.
Embodiment 19. The length of tubing of any of embodiments 1-16, wherein the ratio of ethylene vinyl alcohol copolymer and the one or more fluoropolymers in the barrier mixture is about 1:1 to about 3:1, e.g., about 1:1 to about 2:1; or about 1:1 to about 1.5:1; about 1:1 to about 1.1:1.
Embodiment 20. The length of tubing of any of embodiments 1-19, wherein the barrier mixture further comprises one or more compatibilizers.
Embodiment 21. The length of tubing of embodiment 20, wherein the compatibilizer is selected from the group consisting of a maleic anhydride functionalized fluoropolymer (e.g., PVDF-MA), an anhydride functionalized fluoropolymer, an anhydride functionalized polyethylene, an glycidyl methacrylate functionalized olefin, and a combination or copolymer thereof.
Embodiment 22. The length of tubing of embodiment 20, wherein the compatibilizer is PVDF-MA.
Embodiment 23. The length of tubing of any of embodiments 20-22, wherein the one or more compatibilizers is present in the barrier mixture in a total amount in the range of about 0.01 wt % to about 10 wt %; e.g., in the range of about 0.1 wt % to about 10 wt %, or about 0.1 wt % to about 5 wt %, or about 0.1 wt % to about 2 wt %, or about 0.1 wt % to about 1 wt %, or about 1 wt % to about 10 wt %, or about 1 wt % to about 5 wt %, or about 1 wt % to about 2 wt %, about 2 wt % to about 10 wt %, or about 2 wt % to about 5 wt %, or about 5 wt % to about 10 wt %.
Embodiment 24. The length of tubing of any of embodiments 1-23, wherein the barrier layer has a thickness in the range of 0.010 mm to 0.200 mm, e.g., about 0.010 mm to about 0.150 mm, or about 0.010 mm to about 0.130 mm, or about 0.010 mm to about 0.100 mm, or about 0.010 mm to about 0.075 mm.
Embodiment 25. The length of tubing of any of embodiments 1-23, wherein the barrier layer has a thickness in the range of about 0.030 mm to about 0.200 mm, e.g., about 0.030 mm to about 0.150 mm, or about 0.030 mm to about 0.130 mm, or about 0.030 mm to about 0.100 mm, or about 0.030 mm to about 0.075 mm.
Embodiment 26. The length of tubing of any of embodiments 1-23, wherein the barrier layer has a thickness in the range of about 0.050 mm to about 0.200 mm, e.g., about 0.050 mm to about 0.150 mm, or about 0.050 mm to about 0.130 mm, or about 0.050 mm to about 0.100 mm, or about 0.050 mm to about 0.075 mm.
Embodiment 27. The length of tubing of any of embodiments 1-23, wherein the barrier layer has a thickness in the range of about 0.100 mm to about 0.200 mm, e.g., about 0.100 mm to about 0.150 mm, or about 0.100 mm to about 0.130 mm, or about 0.150 mm to about 0.200 mm, or about 0.170 mm to about 0.200 mm.
Embodiment 28. The length of tubing of any of embodiments 1-22, wherein the barrier layer has a thickness in the range of about 0.2 mm to about 20 mm, e.g., about 0.2 mm to about 15 mm, or about 0.2 mm to about 13 mm, or about 0.2 mm to about 10 mm, or about 0.2 mm to about 5 mm, or about 0.2 mm to about 2 mm, or about 0.5 mm to about 20 mm, or about 0.5 mm to about 15 mm, or about 0.5 mm to about 13 mm, or about 0.5 mm to about 10 mm, or about 0.5 mm to about 5 mm, or about 0.5 mm to about 2 mm, or about 1 mm to about 20 mm, or about 1 mm to about 15 mm, or about 1 mm to about 13 mm, or about 1 mm to about 10 mm, or about 1 mm to about 5 mm, or about 1 mm to about 2 mm, or about 5 mm to about 20 mm, or about 5 mm to about 15 mm, or about 5 mm to about 13 mm, or about 5 mm to about 10 mm, or about 10 mm to about 20 mm, or about 10 mm to about 15 mm.
Embodiment 29. The length of tubing of any of embodiments 1-28, wherein the inner surface of the barrier layer forms the inner surface of the tubing.
Embodiment 30. The length of tubing of any of embodiments 1-28, wherein the annular cross-section further comprises one or more inner annular polymer layers disposed on the inner surface of the barrier layer.
Embodiment 31. The length of tubing of any of embodiments 1-30, wherein the annular cross-section further comprises one or more outer annular support layers disposed on the outer surface of the barrier layer.
Embodiment 32. The length of tubing of embodiment 31, wherein the outer surface of the support layer forms the outer surface of the tubing.
Embodiment 33. The length of tubing of any of embodiments 1-32, having an inner diameter in the range of 0.5 mm to 40 mm.
Embodiment 34. The length of tubing of any of embodiments 1-33, having a length of at least 5 cm, e.g., at least 10 cm, at least 20 cm, at least 30 cm, or even at least 50 cm.
Embodiment 35. The length of tubing of any of embodiments 1-33, having a length of at least 1 m, e.g., at least 2 m, at least 3 m, at least 5 m, or even at least 10 m.
Embodiment 36. The length of tubing of any of embodiments 1-35, wherein the length of tubing exhibits CE10 fuel permeation at 40° C. of less than 15 g/m²/day.
Embodiment 37. A method for transporting a hydrocarbon fuel, comprising
   providing a length of tubing according to any of embodiments 1-36; and
   flowing the hydrocarbon fuel through the flexible tubing from a first end to a second end thereof.
Embodiment 38. A fuel-powered device comprising a fuel tank, a fuel-powered engine, and a length of tubing according to any of embodiments 1-36 fluidly connecting the fuel tank with the fuel-powered engine.
Embodiment 39. The fuel-powered device of embodiment 38, in the form of a marine device, such as a boat, or a jet-ski.
Embodiment 40. The fuel-powered device of embodiment 38, in the form of a hand-operated device, such as a lawn tractor, a string trimmer, a leafblower, a snowblower, a lawnmower, a tiller, or a chain saw.
Embodiment 41. The fuel-powered device of embodiment 38, in the form of an automotive device, such as an automobile, a motorcycle, or a 4-wheel or other recreational vehicles.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

We claim:

1. A length of tubing having an annular cross-section, the annular cross-section having an inner surface and an outer surface, the annular cross-section comprising:
an annular barrier layer formed from a barrier mixture comprising ethylene vinyl alcohol copolymer and one or more fluoropolymers, wherein the combined content of ethylene vinyl alcohol copolymer and the one or more fluoropolymers in the barrier mixture is in an amount of at least 75 wt %, and the barrier layer having an outer surface and an inner surface.

2. The length of tubing of claim 1, wherein the one or more fluoropolymers comprises a PVDF polymer, a CPT polymer, a FEP polymer, a PEA polymer, an ETFE polymer, an EFEP polymer, an ECTFE polymer, a PCTFE polymer, a THV polymer, or a combination or copolymer thereof.

3. The length of tubing of claim 1, wherein the one or more fluoropolymers is a PVDF polymer.

4. The length of tubing of claim 1, wherein ethylene vinyl alcohol copolymer is present in the barrier mixture in an amount in the range of about 20 wt % to about 80 wt %, and the one or more fluoropolymers are present in the barrier mixture in an amount in the range of about 20 wt % to about 80 wt %.

5. The length of tubing of claim 1, wherein ethylene vinyl alcohol copolymer is present in the barrier mixture in an amount in the range of about 30 wt % to about 70 wt %, and the one or more fluoropolymers are present in the barrier mixture in an amount in the range of about 30 wt % to about 70 wt %.

6. The length of tubing of claim 1, wherein ethylene vinyl alcohol copolymer is present in the barrier mixture in an amount in the range of about 45 wt % to about 55 wt %, and the one or more fluoropolymers are present in the barrier mixture in an amount in the range of about 45 wt % to about 55 wt %.

7. The length of tubing of claim 1, wherein the combined content of ethylene vinyl alcohol copolymer and the one or more fluoropolymers in the barrier mixture is in an amount of at least 80 wt %, based on the total weight of the barrier mixture.

8. The length of tubing of claim 1, wherein the ratio of ethylene vinyl alcohol copolymer and the one or more fluoropolymers in the barrier mixture is about 1:3 to about 3:1.

9. The length of tubing of claim 1, wherein the barrier mixture further comprises one or more compatibilizers selected from the group consisting of a maleic anhydride functionalized fluoropolymer, an anhydride functionalized fluoropolymer, an anhydride functionalized polyethylene, an glycidyl methacrylate functionalized olefin, and a combination or copolymer thereof.

10. The length of tubing of claim 9, wherein the compatibilizer is PVDF-MA.

11. The length of tubing of claim 9, wherein the one or more compatibilizers is present in the barrier mixture in an amount in the range of about 0.01 wt % to about 10 wt %; e.g., in the range of about 0.1 wt % to about 10 wt %, or about 0.1 wt % to about 5 wt %, or about 0.1 wt % to about 2 wt %, or about 0.1 wt % to about 1 wt %, or about 1 wt % to about 10 wt %, or about 1 wt % to about 5 wt %, or about 1 wt % to about 2 wt %, about 2 wt % to about 10 wt %, or about 2 wt % to about 5 wt %, or about 5 wt % to about 10 wt %.

12. The length of tubing of claim 1, wherein the barrier layer has a thickness in the range of 0.010 mm to 0.020 mm.

13. The length of tubing of claim 1, wherein the barrier layer has a thickness in the range of about 0.2 mm to about 20 mm.

14. The length of tubing of claim 1, wherein the inner surface of the barrier layer forms the inner surface of the tubing.

15. The length of tubing of claim 1, wherein the annular cross-section further comprises one or more inner annular polymer layers disposed on the inner surface of the barrier layer.

16. The length of tubing of claim 1, wherein the annular cross-section further comprises one or more outer annular support layers disposed on the outer surface of the barrier layer.

17. The length of tubing of claim 1, having an inner diameter in the range of 0.5 mm to 40 mm.

18. The length of tubing of claim 1, wherein the length of tubing exhibits CE10 fuel permeation at 40° C. of less than 15 g/m²/day.

19. A method for transporting a hydrocarbon fuel, comprising
providing a length of tubing according to claim 1; and
flowing the hydrocarbon fuel through the flexible tubing from a first end to a second end thereof.

20. A fuel-powered device comprising a fuel tank, a fuel-powered engine, and a length of tubing according to claim 1 fluidly connecting the fuel tank with the fuel-powered engine.
